(19) United States
(12) Patent Application Publication
(10) Pub. No.: US 2025/0004262 A1
(43) Pub. Date: Jan. 2, 2025

(54) INTERFEROMETRIC IMAGING SYSTEM USING A DIGITAL FOCAL PLANE ARRAY

(71) Applicants: Massachusetts Institute of Technology, Cambridge, MA (US); The General Hospital Corporation, Boston, MA (US)

(72) Inventors: Matthew R Johnson, Medford, MA (US); Michael C Bradshaw, Medford, MA (US); Guillermo J Tearney, Boston, MA (US); Joseph A. Gardecki, Boston, MA (US); Osman Oguz Ahsen, Boston, MA (US)

(21) Appl. No.: 18/215,395

(22) Filed: Jun. 28, 2023

(51) Int. Cl. G02B 21/00; G01J 3/45; G02B 21/36

(52) U.S. Cl. CPC G02B 21/0056; G01J 3/45; G02B 21/367

(57) ABSTRACT

An apparatus for obtaining interferometric data, including: an optical detector to detect the interferometric data, the optical detector including at least one pixel, and the at least one pixel including at least one counter configured to count photoelectrons.

### STATEMENT REGARDING FEDERALLY SPONSORED RESEARCH

This invention was made with government support under Prime Contract FA8702-15-D-0001 awarded by AFLCMC/AZS Hanscom AFB. The government has certain rights in the invention.

### BACKGROUND

Visualizing subsurface biological tissue, particularly at subcellular (˜1 μm) resolution, can only be accomplished ex vivo. However, to do this requires obtaining samples using procedures such as biopsies which may be inconvenient, painful, and/or harmful to a subject and which remove the tissue from its native environment and typically require fixation and processing of the tissue for observation.

### SUMMARY OF THE INVENTION

Accordingly, new systems, methods, and apparatus for obtaining images in vivo or ex vivo with faster imaging time, higher signal-to-noise (SNR), and/or greater imaging depth are desirable.

In various embodiments, Digital Focal Plane Array (DFPA) technology may be employed as the imaging element of interferometric imaging systems such as those used for Optical Coherence Tomography (OCT) to increase the system sensitivity, imaging speed, imaging depth, and/or dynamic range.

Disclosed herein are embodiments of procedures for creating “virtual tissue sections” with resolution similar to that employed in the gold standard for pathology, in vivo, without disturbing the tissue, and at an image rate fast enough to directly observe subcellular metabolic functions. Applications of these procedures include improved disease diagnosis, advanced drug development, and better understanding of basic life sciences. In various embodiments, the procedures will leverage a suite of features unique to MIT Lincoln Laboratory's (MIT-LL) Digital Focal Plane Array (DFPA) technology.

In one embodiment, an apparatus for obtaining subcellular resolution images in vivo, including: a full-field optical coherence microscopy (FFOCM) system; and an imaging device optically employed in the FFOCM system, the imaging device including at least one of a high well capacity, a high frame rate, high visible wavelength sensitivity, high infrared sensitivity, in-pixel computation, up/down counting, orthogonal pixel transfer, or read-while integrate. In certain embodiments, the needs of imaging speed and resolution levels in a particular implementation can be balanced to collect image data at a sufficiently fast rate to capture images in vivo, obtain images with finer detail (i.e. improved signal-to-noise), and/or image a particular plane or volume of a sample with sufficient frequency to observe cellular dynamics (termed dynamic-FFOCT/M).

Various embodiments of the disclosed devices will overcome one or more limitations of present FFOCM and/or interferometric imaging technologies. Accordingly, in particular embodiments the disclosed technology may be utilized to image ex vivo (e.g. for use in drug development) samples such that the benefits of such DFPA containing devices may include one or more of: 1. Faster imaging time (to facilitate in vivo/ex vivo imaging); 2. Higher SNR for a given imaging rate (e.g., using a brighter source light); 3. Higher overall SNR; and/or 4. Ability to image deeper into tissue (e.g., due to one or both of suitable wavelength selection and/or use of brighter source light).

In another embodiment, a method for obtaining subcellular resolution images in vivo, including: obtaining at least one image using an apparatus for obtaining subcellular resolution images in vivo as disclosed herein; and identifying at least one subcellular structure in the at least one image.

In yet another embodiment, an apparatus for obtaining interferometric data, including: an optical detector to detect the interferometric data, the optical detector including at least one pixel, and the at least one pixel including at least one counter configured to count photoelectrons.

In still another embodiment, a method for obtaining interferometric data, including: detecting, using an optical detector, the interferometric data, the optical detector including at least one pixel, and the at least one pixel including at least one counter configured to count photoelectrons.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows a diagram of biological samples and relative sizes thereof (top panel) along with a chart showing the ability of various technologies to image biological materials (bottom panel).

FIG. 2 shows a diagram of skin tissue along with criteria for burn damage assessment, which demonstrates a potential use for the disclosed procedures.

FIG. 3 shows side by side diagrams of procedures for tumor resectioning and biopsy compared to procedures for a DFPA-enabled FFOCM method.

FIG. 4A shows a simplified diagram of a basic FFOCM setup where Xe is a xenon arc lamp; ND is a neutral density filter; BS is a beam splitter cube; OL is a microscope objective lens; GP is a glass plate; DAQ is a data acquisition board in a computer; PZT is a piezoelectric transducer.

FIG. 4B shows a simplified diagram of a typical optical setup of single point OCT, where scanning of a light beam on the sample enables non-invasive cross-sectional imaging up to 3 mm in depth with micrometer resolution.

FIG. 4C shows a simplified diagram of an optical setup for spectral discrimination by Fourier-domain OCT. Components include: low coherence source (LCS), beamsplitter (BS), reference mirror (REF), sample (SMP), diffraction grating (DG), and full-field detector (CAM) acting as a spectrometer, and digital signal processing (DSP).

FIG. 4D shows a simplified diagram of an optical setup for spectral discrimination by swept-source OCT. Components include: swept source or tunable laser (SS), beamsplitter (BS), reference mirror (REF), sample (SMP), photodetector (PD), and digital signal processing (DSP).

FIG. 4E shows a simplified diagram of an optical setup for a streak-mode Fourier domain optical coherence tomography system. (see Wang, Rui et al. (2012). 4D imaging of embryonic chick hearts by streak-mode Fourier domain optical coherence tomography. Proc. SPIE. 8207. 72. 10.1117/12.907156, which is incorporated by reference herein in its entirety).

FIG. 5 shows a diagram of another embodiment of an FFOCM system.

FIG. 6 shows a comparison of a traditional analog readout integrated circuit (IC) vs. a DFPA digital readout IC.

FIG. 7A shows graphs comparing Maximum Permissible Exposure (MPE) for CMOS and DFPA cameras and FIG. 7B shows graphs comparing Penetration Depth vs. Wavelength for CMOS and DFPA cameras.

FIG. 8 shows graphs related to requirements for a light source for a SIRP system, including graphs of MPE for skin (upper left), sensor quantum efficiency (lower left), optical absorption of water (upper right), and optical penetration of human skin (lower right).

FIG. 9 shows an image volume that can be acquired using an FFOCM system.

FIG. 10 provides a system block diagram of a DFPA-based FFOCM for performing SIRP.

FIG. 11 provides a side view diagram of a SIRP layout showing the coupling between the light source and sample arm.

FIG. 12 provides a side view diagram of a SIRP layout showing the coupling between the reference arm and the camera.

FIG. 13 provides an analysis of light source power requirements for various embodiments of a SIRP system.

FIGS. 14 and 15 provide analyses of objective lens requirements for various embodiments of a SIRP system.

FIG. 16 shows the single-frame sensitivity for the DFPA operating in 16-bit counter mode and 32-bit counter mode (neglecting other noise sources), plotted against sensitivity achieved with state-of-the-art camera technology in 2004 and 2019.

FIG. 17 shows interferometric images of a 1951 USAF target (inset, left) taken with a commercial camera (center) and the DFPA (right).

FIG. 18 shows an axial intensity plot of the full dynamic range of the DFPA when operating in 32-bit mode (left), the demonstrated dynamic range of the presently constructed FFOCM system with a DFPA (upper right), and a COTS camera (Sensors Unlimited) (lower right).

FIG. 19 shows how the up/down counting function of the DFPA can be used to perform addition and subtraction, resulting in a method of reducing the number of camera readout cycles necessary to produce an image.

FIG. 20 shows how the DFPA's two counters can alternate between readout and integrate functions, resulting in a system that continuously captures data without the “dead time” that results from circuitry readout.

FIG. 21 shows unwanted photons from a configuration similar to that shown in FIG. 4A, which will result in a high “background” signal.

### DETAILED DESCRIPTION

In accordance with some non-limiting embodiments of the disclosed subject matter, mechanisms (which can include systems, methods, and apparatus) for obtaining images in vivo or ex vivo with faster imaging time, higher signal-to-noise (SNR), and/or greater imaging depth are provided.

Thus, in various embodiments the disclosure provides apparatus, methods, and systems for obtaining interferometric data. The apparatus may include an optical detector to detect the interferometric data, where the optical detector may include at least one pixel and the at least one pixel may include at least one counter configured to count photoelectrons. The interferometric data may include data or images that result from an interferometric combination of a plurality of electromagnetic beams that is measured by the optical detector. The interferometric data may be obtained from various samples (e.g., from a human or other animal) including in vivo and/or ex vivo samples and may be obtained from surface and/or subsurface features on the sample. In some embodiments, the interferometric data that is obtained may provide subcellular information and may be capable of resolving features in the sample (in lateral and/or axial directions) less than 10 μm, less than 5 μm, less than 3 μm, less than 2 μm, less than 1 μm, less than 0.5 μm, and/or less than 0.25 μm.

In various embodiments, the at least one pixel of the optical detector may include a linear array of elements and/or a two-dimensional array of elements. In certain embodiments, the optical detector may include a Digital Focal Plane Array (DFPA) such as those described herein. In some embodiments a responsivity of the optical detector may be in a wavelength range that is determined by a spectral responsivity of a material including an optical/electrical interface of the optical detector.

In some embodiments, the DFPA may perform an in-pixel computation, where the in-pixel computation may include at least one of addition or subtraction. In certain embodiments the DFPA may include a spectral responsivity in a range of 900 nm-1400 nm, and in other embodiments the DFPA may include a spectral responsivity in a range of 400 nm-1100 nm. Other ranges of spectral responsivity in the UV, visible, and/or infrared range are also possible.

In particular embodiments, the optical detector may include a readout integrated circuit (ROIC) and a dynamic range of the optical detector may be a function of the ROIC. In some embodiments, the ROIC may include a 16-bit counter and a capacitor which may yield a least significant bit of 2000 electrons such that a pixel saturation level may include 130×10⁶ photoelectrons. In other embodiments, the ROIC may include a 32-bit counter and a capacitor yielding a least significant bit of 2000 electrons such that a pixel saturation level may include 8.5×10¹² photoelectrons. In certain embodiments a first counter of the ROIC may read out data while a second counter counts photoelectrons, such that the optical detector may be configured to perform a read-while-integrate operation. In various embodiments, a counter of the ROIC may be pre-set to remove a DC level corresponding to a background light level.

In various embodiments, the interferometric data may be obtained from one or more of an interferometric system including an optical coherence microscopy (OCT) imaging system; a full-field optical coherence microscopy (FFOCM) imaging system; and/or a Fourier Transform Infrared Spectroscopy (FTIR) system.

In some embodiments, the optical detector may include readout times supporting a frame rate of at least 1 kHz. In other embodiments, the optical detector may include an effective well capacity of greater than 2×10⁶ electrons. In particular embodiments, the optical detector may include pixel shifting to implement at least one of spatial filtering or image stabilization.

Various embodiments of the disclosure also provide methods and/or systems for obtaining interferometric data as disclosed herein, using various embodiments of the apparatus disclosed herein.

An en face version of Optical Coherence Tomography (OCT) called Full-field Optical Coherence Microscopy (FFOCM) has been shown capable of producing “virtual image slices” with sufficient voxel resolution (˜1 μm³) for histological analysis of small tissue volumes (e.g. volumes having lateral dimensions of approximately hundreds of micrometers), without requiring the physical sectioning and/or staining process of a typical biopsy procedure. Since the tissue samples need to be excised for current FFOCM, however, the process still carries with it most of the disadvantages of biopsying and preparing frozen sections (the current gold standards in the field). In addition, imaging depth into the tissue is limited by the sensor's responsivity. As a result, adoption of FFOCM has been limited.

In general, samples for FFOCM analyses are excised from the subject because current cameras cannot image fast enough to overcome blur which may occur during in vivo imaging. Specifically, present camera technology may suffer from one or more of:
1. Limited Spectral responsivity (visible spectrum for high framerate imagers);
2. Small full-well Capacity (FWC=2e6 (2×10⁶), maximum number of electrons each pixel can hold per integration time, beyond which the pixel is saturated); and/or
3. Inadequate frame rate.

Though selecting an optical illumination source within the biological window (e.g. near infrared, NIR, in a range of ˜900-1400 nm) would be beneficial due to the deeper optical penetration in tissue of NIR relative to the visible wavelength range and much higher Maximum Permissible Exposure (MPE) limits, technological advances in CMOS imagers have provided enough benefit in terms of FWC and frame rate that they have been used for most modern advances in FFOCM. This is due in part to the fact that CMOS has its highest responsivity in the visible wavelength range, and therefore an optical illumination source in the visible range is employed in FFOCM systems; however, due to the limited penetration of visible light into biological tissue, SNR in such systems quickly reduces as a function of imaging depth.

Key performance advancements in FFOCM have largely been the result of increased FWC and framerates in CMOS cameras. Though the current state-of-the-art FFOCM system has a purpose-built CMOS camera with a FWC of 2e6 electrons, to avoid detector saturation, the illumination source intensity is still operated well below the Maximum Permissible Exposure (MPE). For example, recent work in FFOCM employed an incident fluence of about 7% of the Maximum Permissible Exposure (MPE), which leaves opportunity for increased SNR if the detector had an even higher FWC.

The purpose-built CMOS camera used in the work referenced above has 1440×1440 pixels and a frame rate of 720 fps, which is adequate to capture subcellular dynamics. Nonetheless, overall system performance is still limited by the visible wavelength employed and the limited FWC. A preliminary search of imagers with responsivity within the biological window (e.g. NIR wavelengths) yielded only imagers with frame rates below 100 Hz.

Accordingly, various embodiments of the disclosure provide interferometric imaging systems which improve on prior systems, including having an imaging device which has one or more of increased well capacity, high frame rates, and/or detection in the IR/NIR range. In particular embodiments, the disclosed systems take advantage of several unique features of the Lincoln Laboratory-developed Digital Focal Plane Array (DFPA) to deliver an imaging technology not possible with current sensors. These features include:
1. virtually unlimited well capacity (as set by the bit-depth of the in-pixel counter(s) OR by allowing the counter to roll over, further extending the effective well-depth),
2. In-pixel computation which among other capabilities, can remove DC bias,
3. readout times sufficient to support a frame rate of at least 1 kHz (to provide real-time imaging capability),
4. ability to select which waveband to use for imaging, including: (a) near infrared (NIR)/shortwave infrared (SWIR) when hybridized with an InGaAs detector), and/or (b) visible waveband when hybridized with a CMOS detector,
5. on-board pixel shifting (enabling spatial filtering and image stabilization),
6. ability to read while integrating.

Nevertheless, while the above features may be desirable for certain implementations that incorporate the DFPA, in various embodiments certain features may become less important. For example, depending on factors such as the volume being imaged, readout circuitry bus speed, necessary signal strength, etc., a frame rate of at least 1 kHz may be less important in some instances.

With the DFPA employed as the imager in embodiments of a purpose-built Full-field Optical Coherence Microscopy (FFOCM) system, the speed will be sufficient for in vivo imaging as well as for direct observation of subcellular metabolic functions, at depths of approximately 4 mm or deeper.

Various embodiments of the disclosed procedures may transform numerous facets of healthcare delivery and research, including the study of progressive drug effects on living cells as enabled by time-series analysis (aka. dynamic OCT) of subcellular activity, comprehensive in vivo “biopsies” free of spatial sampling errors, and determination of tumor boundaries during resection. In some embodiments, the imaging capability may be combined with artificial intelligence (AI) analysis for more comprehensive automated screening and diagnosis.

As described herein, the limiting component for FFOCM systems has been and continues to be the camera technology. Advancements have sought to increase the camera full-well capacity and frame rate, but the architecture of the camera has largely remained constant. As a result, the full-well capacity has been limited by the size of the pixel capacitor. Though this capacitor size has increased, it still yields a dynamic range that is orders of magnitude lower than achieved by the fundamentally different approach that the DFPA technology uses by counting photoelectrons via a counter in each pixel. In addition, traditional camera architectures do not offer on-camera pixel shifting or up/down counting (e.g. to AC-couple the light). Though CMOS (e.g. visible waveband) cameras are inexpensive and can have fast frame rates, commercial InGaAs cameras (e.g. operating in the near-infrared waveband) tend to have lower frame rates and have costs on the order of $10-$80, and have lower FWC. While it may be possible to compensate for the deficiencies of certain cameras by increasing the gain, this can come at the cost of bit-resolution due to the increased number of electrons per bit.

Future users of the technology may include healthcare technology providers involved in the commercialization of tools for intra-operative tissue-state diagnosis, patient health screening, bioengineering research, and drug development. In addition, OEMs for scientific cameras may also be interested in the DFPA technology.

Thus, compared to state-of-the-art technologies, embodiments of an FFOCM imaging system disclosed herein may be two orders of magnitude faster and produce images two times deeper into a tissue. Furthermore, using these and other disclosed embodiments, tissue does not need to be excised (i.e. the imaging is done in vivo, not ex vivo) and no staining of the tissue is required.

Accordingly, in various embodiments a DFPA imaging device may be used to close the “technology gap” that has heretofore limited the extension of FFOCM to uses such as high frame rate in vivo volumetric imaging, providing a technology which allows imaging of cellular structure and metabolism, two key classes of parameters that are needed to diagnose disease and tissue viability. Applications of these procedures, referred to as System for In Vivo Real-time Pathology (SIRP), include one or more of biopsy-free cancer screening, burn assessment, rapid drug development, microvascular assessment (such as assessment of microvascular repairs, e.g. free flaps), triage of abdominal blast injuries, investigation of damage mechanisms for directed energy attacks, and/or exploration of the fundamentals of wound healing. In various embodiments, the procedures may be used to evaluate high throughput tissue samples; while such samples are presently evaluated using dynamic μOCT, it can take many hours to image a single chip with organoids on it, whereas using a DFPA-based FFOCM system it will be possible to speed up the process to enable assessment of individualized patient tissue response to therapy.

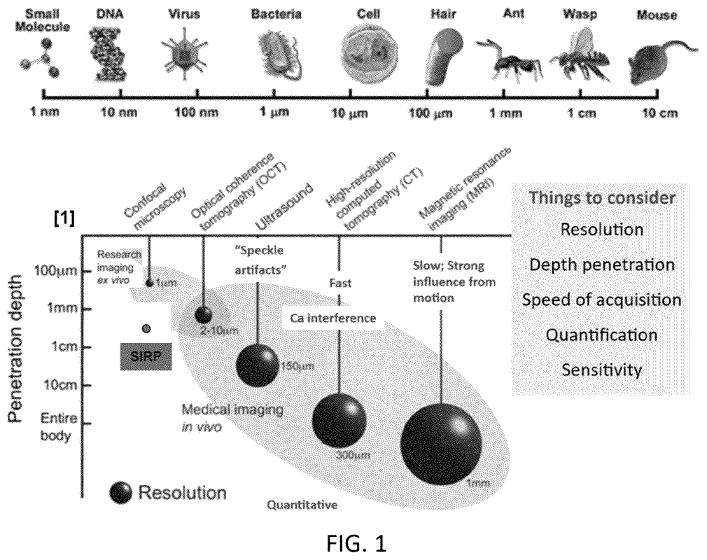

FIG. 1 shows a diagram of biological samples and relative sizes thereof (top panel) along with a chart showing the ability of various technologies to image biological materials (bottom panel), including indications of the penetration depth and the approximate resolution.

Embodiments of the present device are capable of rapid, subcellular in vivo volumetric tissue imaging providing data collection rates that are at least two orders of magnitude faster and image into samples two times deeper than current state of the art systems. Furthermore, these procedures do not require tissue to be excised and use illumination modalities that are non-ionizing. The result is that these procedures will facilitate direct observation of presently un-observable biological conditions and mechanisms.

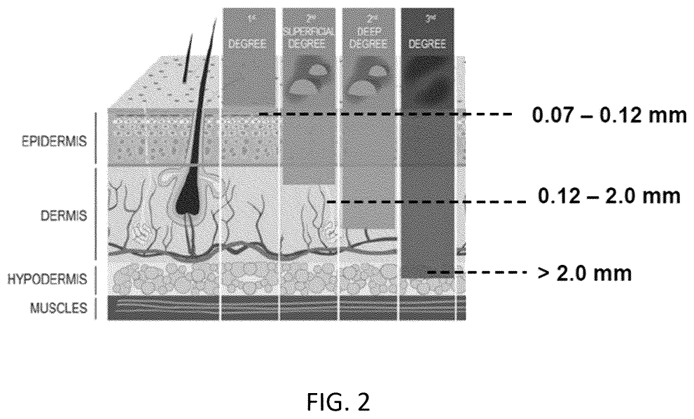

One particular embodiment of the disclosed technology is for the detailed assessment of deep burns, due to imaging depth and in vivo capability provided by SIRP systems. FIG. 2 shows a diagram of skin tissue along with criteria for burn damage assessment, which demonstrates a potential use for the disclosed procedures. Determining depth of burn over an entire affected area is a crucial first step to planning treatment. Non-specialists may be 60% accurate in their diagnosis while specialists may be 70-80% accurate. First degree and superficial second degree are shallow and relatively easy to diagnose, and treatment of such burns is relatively straightforward. However, deep second degree and third degree burns are difficult to differentiate between and require more complex treatment and monitoring. Existing all-optical techniques for burn assessment are limited in depth and/or are too slow for use in vivo, and as a result are limited in utility when imaging, generally not imaging deep enough into tissue for obtaining most meaningful diagnostic information. Embodiments of the disclosed SIRP procedures, on the other hand, can image deeper into the tissue and can be used in vivo, overcoming limitations of current technology.

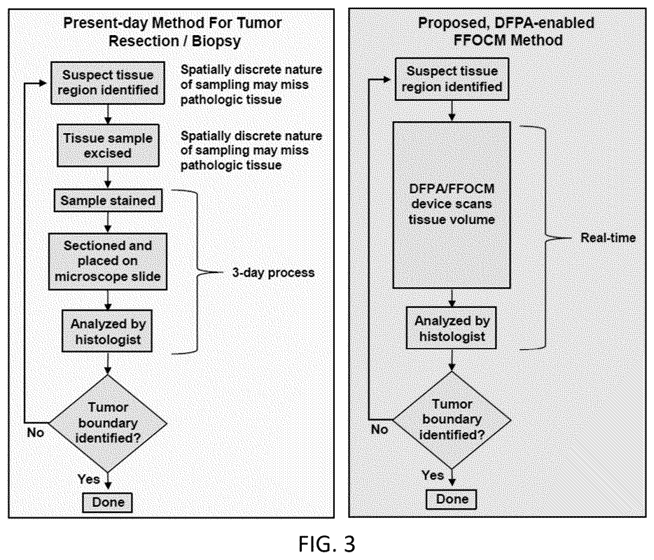

FIG. 3 shows side by side diagrams of procedures for tumor resectioning and biopsy compared to procedures for a DFPA-enabled FFOCM method. As seen in FIG. 3, the main difference is in the intermediate steps of present methods which entail excising a tissue sample and staining and sectioning the sample, which is replaced by in vivo imaging in the SIRP procedure. Table 1 below shows a comparison of biopsy vs. SIRP parameters.

TABLE 1

| | Biopsy | SIRP |
|---|---|---|
| Tissue state | Ex vivo | In vivo |
| Time-series analysis possible? | No | Yes |
| Tissue left undisturbed? | No | Yes |
| Entire physical area evaluated? | No | Yes |
| Free of side-effects? | No | Yes |
| Turnaround time | >3 days | Real-time |
| Cost | Expensive | Inexpensive |

### Overview of FFOCM

Optical Coherence Tomography (OCT) provides low coherence interferometry for 3D microscopic imaging and traditionally uses lateral scanning of a single beam to produce 3D images. FFOCM on the other hand is an en face version of OCT which uses an array of pixels to simultaneously capture all lateral points in image, while scanning a reference to obtain a depth profile (in the time domain). FFOCM provides faster acquisition of a full imaging volume (i.e. a full field) and can make use of high numerical aperture (NA) objective lenses for high resolution (Optical Coherence Microscopy). In view of the limitations of the technology, improving the speed and depth of FFOCM has been an active research area for some time. As the methods and general optical system design of FFOCM are well established, most improvements have been to the camera component.

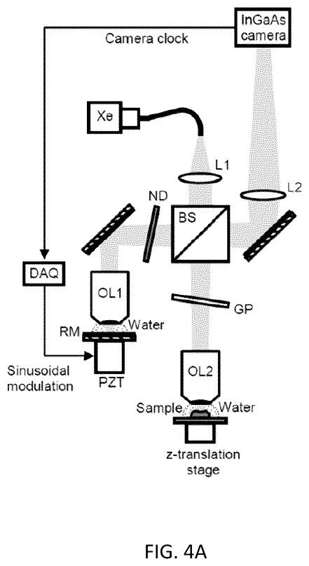

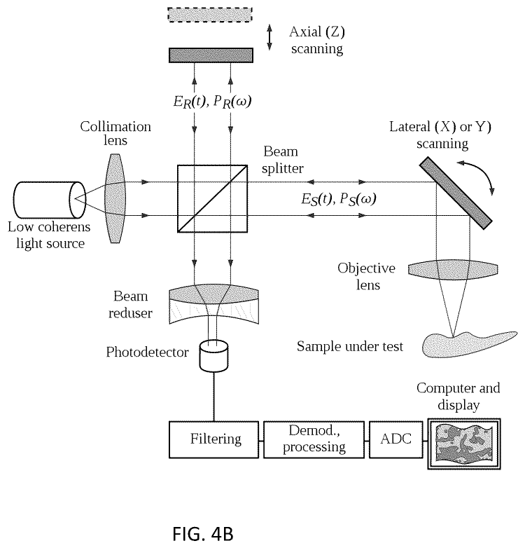

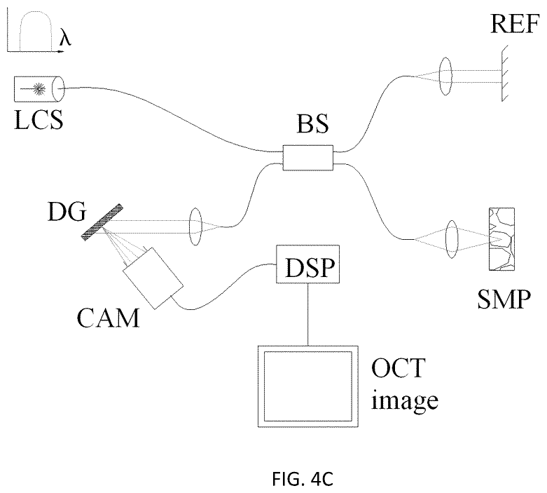

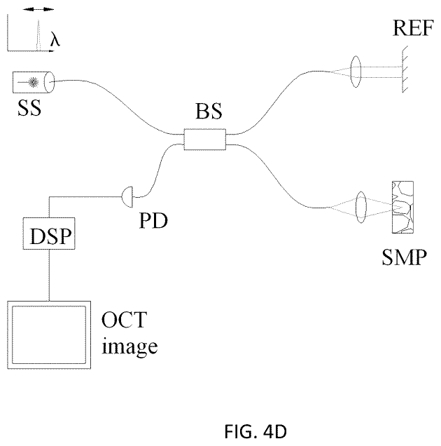

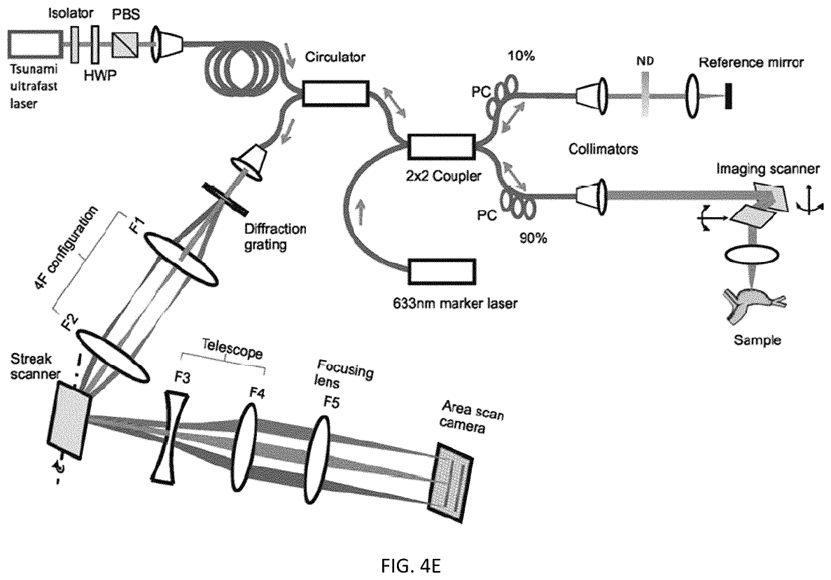

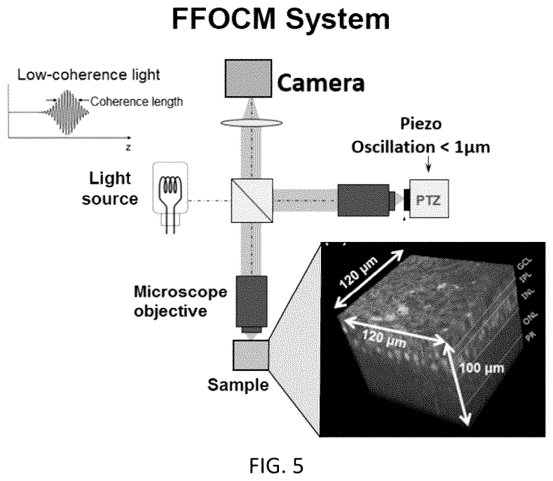

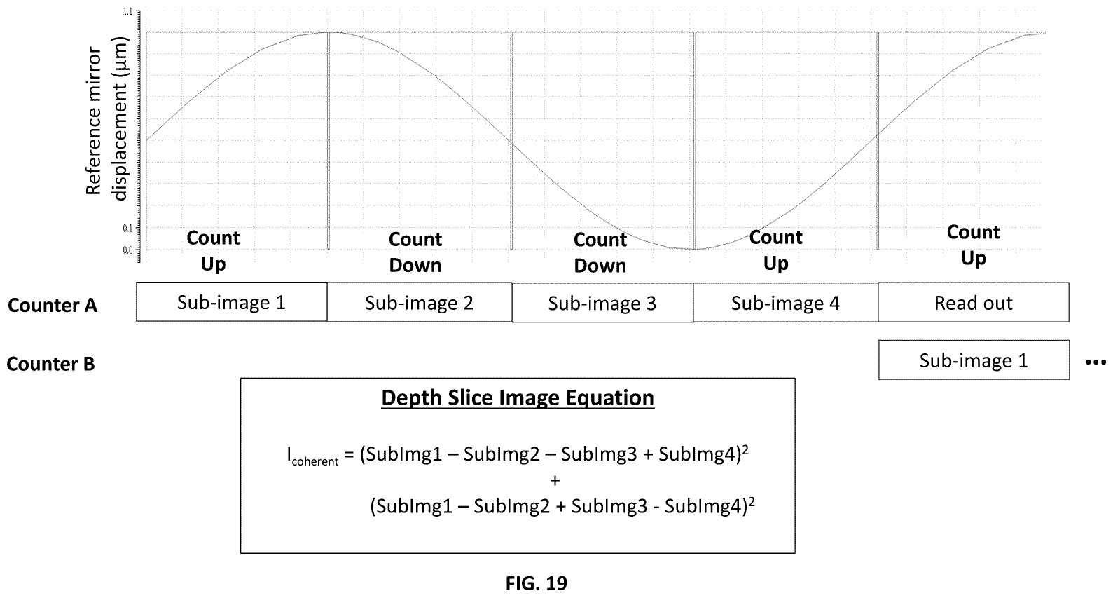

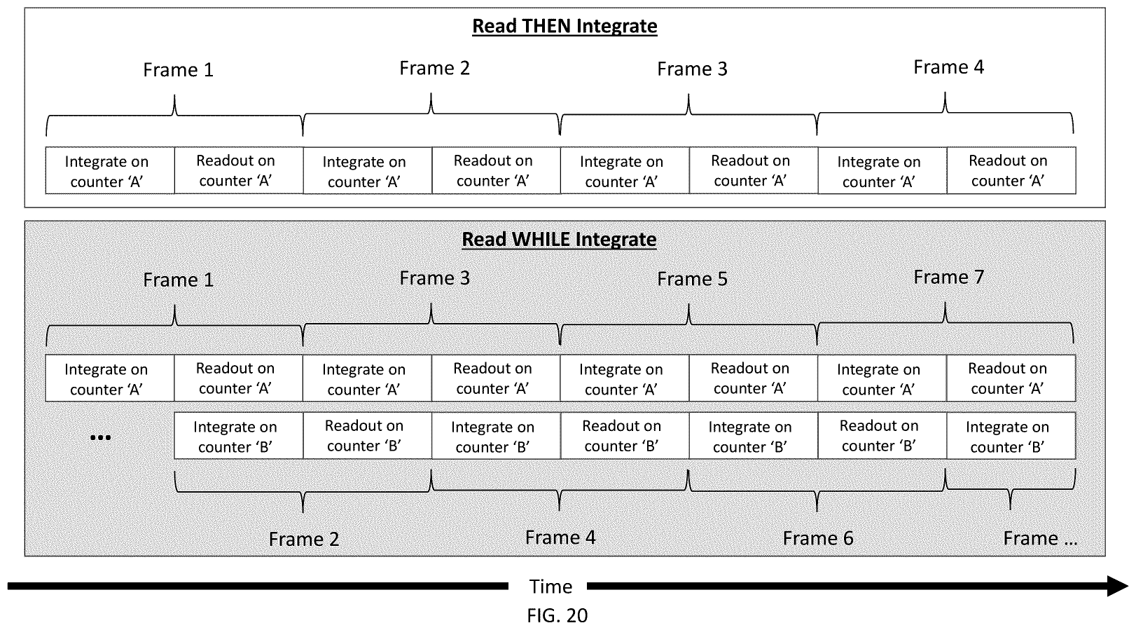

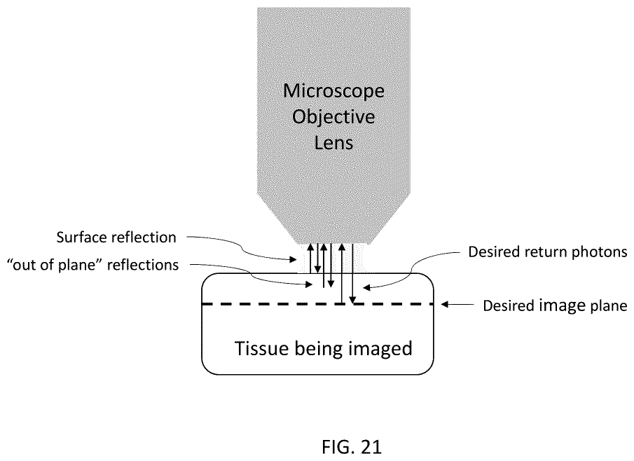

Presented as non-limiting examples of interferometric imaging systems, FIGS. 4A-4E and 5 show systems that could use the DFPA as the camera/sensing element. The advantages to these systems could be realized through employment of one or more of the DFPA features. The high “pedestal” of light that results from photons reflected from anywhere other than the image plane of interest (see FIG. 21) can effectively be removed either by setting the DFPA's counter to a negative number about equal to the pedestal intensity, or the pedestal can be removed by subtraction after frame capture. The readout times can be increased by employing the Read While Integrate function shown in FIG. 20, effectively doubling the frame rate for the instance that the sensor integration time is equal to the DFPA readout time. The up/down counting function shown in FIG. 19 can be used to decrease the number of frames requiring readout, improving the effective frame rate. Due to the theoretically infinite dynamic range of the DFPA (given proper accounting of the counters rollover), all imaging systems can be limited in power not by the saturation level or dynamic range of the sensing element, but rather by the Maximum Permissible Exposure limit of the element being imaged. For example, for the case of skin, the maximum light intensity can be up to that set by safety guidelines.

FIG. 4A shows a diagram of a basic FFOCM setup where Xe is a xenon arc lamp; ND is a neutral density filter; BS is a beam splitter cube; OL is a microscope objective lens; GP is a glass plate; DAQ is a data acquisition board in a computer; PZT is a piezoelectric transducer (see Oh et al., “Ultrahigh-resolution full-field optical coherence microscopy using InGaAs camera,” Opt. Express 14, 726-735 (2006), incorporated herein by reference in its entirety).

FIG. 4B shows a simplified diagram of a typical optical setup of single point OCT, where scanning of a light beam on the sample enables non-invasive cross-sectional imaging up to 3 mm in depth with micrometer resolution. In this use-case, a single pixel of the DFPA could be used as a photodetector with very large dynamic range, encompassing all or much of the blocks indicated as Filtering, Demodulation processing, and ADC.

FIG. 4C shows a diagram of a simplified optical setup for Spectral discrimination by Fourier-domain OCT. Components include: low coherence source (LCS), beamsplitter (BS), reference mirror (REF), sample (SMP), diffraction grating (DG) and full-field detector (CAM) acting as a spectrometer, and digital signal processing (DSP).

FIG. 4D shows a simplified optical setup for Spectral discrimination by swept-source OCT. Components include: swept source or tunable laser (SS), beamsplitter (BS), reference mirror (REF), sample (SMP), photodetector (PD), and digital signal processing (DSP).

FIG. 4E shows a simplified optical setup for a streak-mode Fourier domain optical coherence tomography system. (see Wang, Rui et al. (2012). 4D imaging of embryonic chick hearts by streak-mode Fourier domain optical coherence tomography. Proc. SPIE. 8207. 72. 10.1117/12.907156, which is incorporated by reference herein in its entirety).

The following are parameters of one embodiment of an FFOCM system, although variations on these specific values may be made: light source: Oriel 6263, xenon arc lamp; objective lens: Optics for Research (OFR-LMO 20×; 0.45 NA in air), working distance WD=2.1 mm; piezoelectric transducer: AE0505D16 Thorlabs for reference mirror; lateral resolution: 2 μm; axial resolution: 1.9 μm; field of view: 320×260 μm; NA: 0.45; magnification: 20×; WD: 2.1.

FIG. 5 shows a diagram of another embodiment of an FFOCM system. Table 2 shows a chart of key camera parameters showing the system effect of each. While current state of the art systems can obtain a sample such as that shown in the inset of FIG. 5 (120 μm×120 μm×100 μm) ex vivo in 12 sec, a DFPA-enabled FFOCM device may obtain such a sample in vivo in 0.2 sec.

TABLE 2
Key Camera Parameters

| | System Effect | | |
|---|---|---|---|
| Camera Parameter | Speed | Depth | Resolution |
| Pixel saturation | X | X | |
| (full-well capacity) | | | |
| Read while integrate | X | | |
| Frame rate | X | | |
| Quantum efficiency | X | X | X |
| and bandwidth | | | |

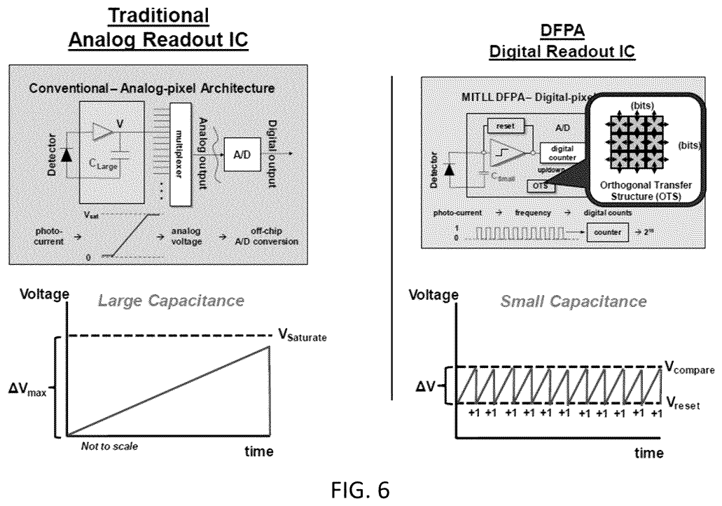

FIG. 6 shows a comparison of a traditional analog readout integrated circuit (IC) vs. a DFPA digital readout IC. Table 3 shows a comparison of key camera parameters for a CMOS vs. a DFPA camera, highlighting the differences in pixel saturation, ability to read while integrating, and frame rate, showing that the DFPA camera has fundamental features that provide improved performance and advanced capabilities.

TABLE 3
Key Camera Parameters

System Effect

| Camera Parameter | CMOS | DFPA |
|---|---|---|
| Pixel saturation (full-well | 2e6 | 130e6 (16-bit) |
| capacity; e−) | | 8.5312 (32-bit |
| Read while integrate | No | Possible |
| Frame rate (kHz) | 0.4-0.72 | 1-2 |
| Quantum efficiency and | | |
| bandwidth (Half-power | | |

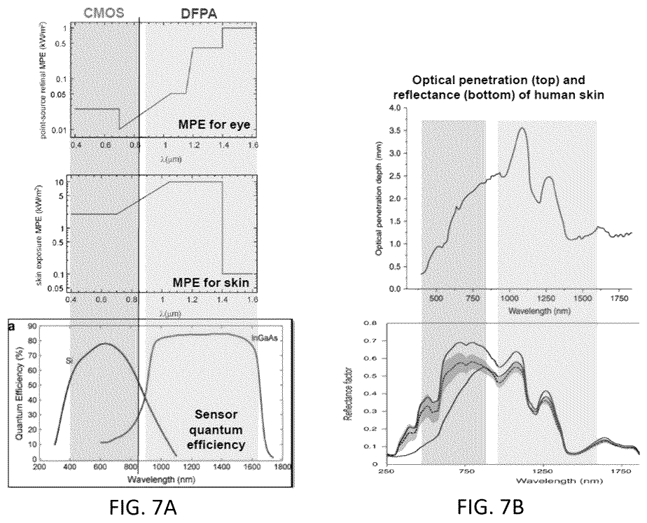

FIG. 7A shows graphs comparing Maximum Permissible Exposure (MPE) for CMOS and DFPA cameras and FIG. 7B shows graphs comparing Penetration Depth vs. Wavelength for CMOS and DFPA cameras. Table 4 shows a comparison of key camera parameters for a CMOS vs. a DFPA camera, highlighting the quantum efficiency and bandwidth. While FFOCM speed is presently limited by the full-well capacity (FWC) of the camera, the data shows that using a DFPA camera shifts the limit to be the Maximum Permissible Exposure (MPE).

TABLE 4
Key Camera Parameters

System Effect

| Camera Parameter | CMOS | DFA |
|---|---|---|
| Pixel saturation (full-well | 2e6 | 130e6 (16-bit) |
| capacity; e−) | | 8.5e12 (32-bit) |
| Read while integrate | No | Possible |
| Frame rate (kHz) | 0.4-0.72 | 1-2 |
| Quantum efficiency and | 400-850 | 900-1650 |
| bandwidth (Half-power) | | |

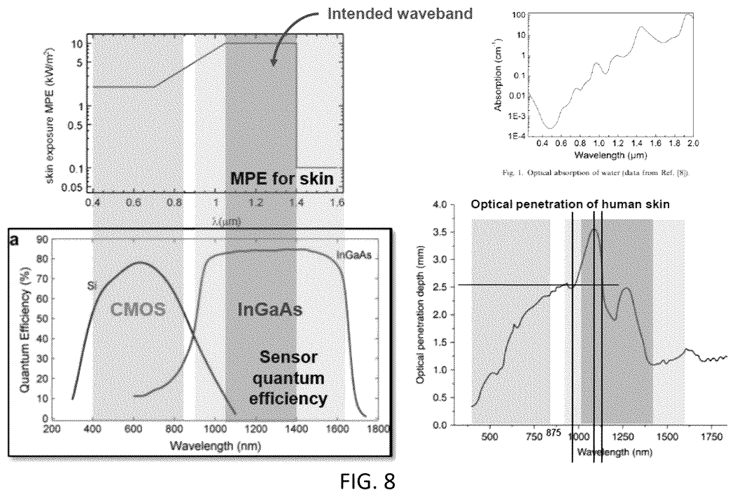

FIG. 8 shows graphs related to requirements for a light source (wavelength and bandwidth) for a SIRP system, including graphs of MPE for skin (upper left), sensor quantum efficiency (lower left), optical absorption of water (upper right), and optical penetration of human skin (lower right). As shown in the graphs, the wavelength range with the highest MPE is 1050-1400 nm, and so this entire waveband could be utilized to obtain good axial resolution. The center wavelength f_{c}=1225 nm, the bandwidth=350 nm, and the axial resolution=1.42 μm (see Eq. (1) below).

$$Δ z = \frac{2 ln 2}{n π} ( \frac{{λ}^{2}}{Δλ} ) \qquad ( 1 )$$

However, given the use of a water immersion lens and high water absorbance as the wavelength 2 increases to 1.4 μm, it may be preferable in certain embodiments to shift the waveband to a shorter wavelength region despite reduced MPE to reduce the amount of water-based light absorption. This would also increase the lateral resolution of the system.

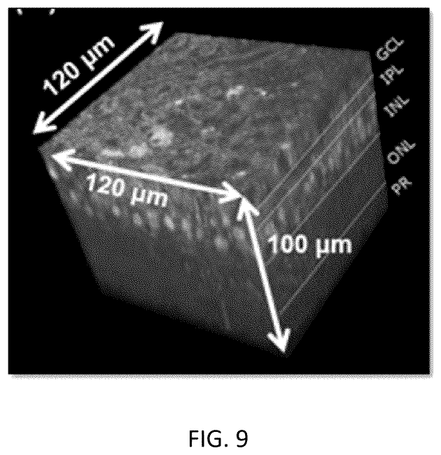

FIG. 9 shows an image volume that can be acquired using a SIRP system, while Equation (2) shows a formula for a minimum detectable signal Rₘᵢₙ:

$${R}_{min} = \frac{{( {R}_{ref} + 2 {R}_{inc} )}^{2}}{2 N {ξ}_{sat} {R}_{ref}} \qquad ( 2 )$$

where R_{ref}=Reflectivity of reference mirror (2%), R_{inc}=Reflectivity of sample (1%), N=number of accumulated images (1), and ξₛₐₜ=Full-well capacity of camera (varies). While a state-of-the-art CMOS camera must average over 75 frames to get adequate signal strength, DFPA can capture all of the necessary photons in one frame and thus take advantage of higher MPE. Table 5 shows a comparison of camera parameters for CMOS and DFPA cameras, highlighting the fact that a DFPA camera can obtain an image volume in 0.2 sec, compared to 15 sec for a CMOS camera. Thus, it is clear that DFPA holds promise to adequately reduce image-volume acquisition speed sufficient for in vivo imaging.

TABLE 5

| | CMOS | DFPA |
|---|---|---|
| | (Best available) | (InGaAs) |
| Wavelength [nm] | 850 | 1150 |
| Maximum irradiation | 1.4 (limited to 7% of MPE | 500 |
| [W/m²] | due to camera saturation) | |
| Time to image volume | 15 seconds | 0.2 sec |

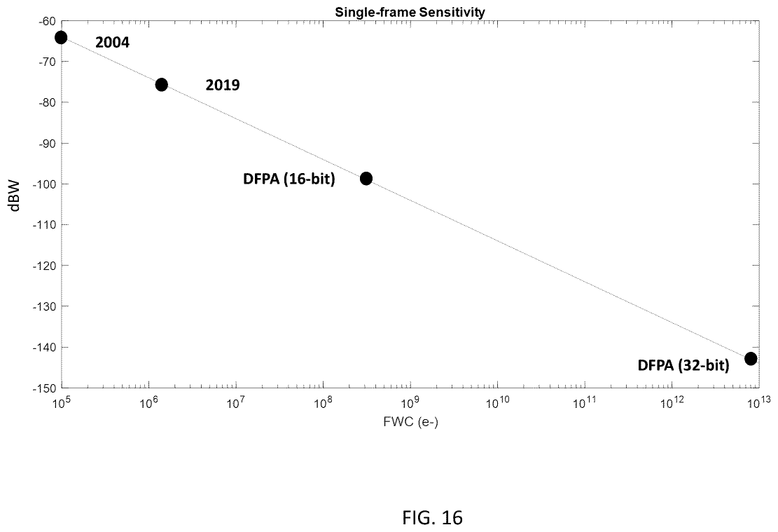

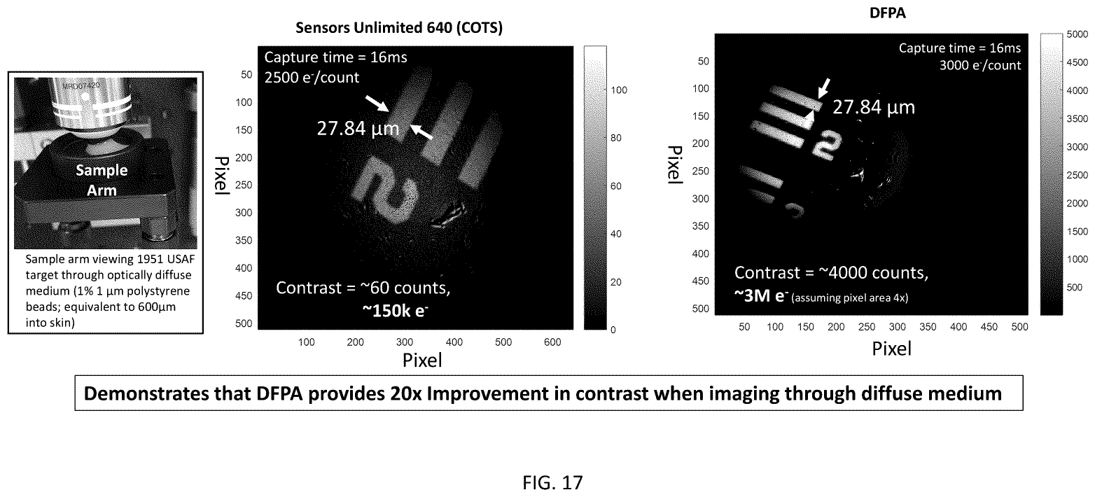

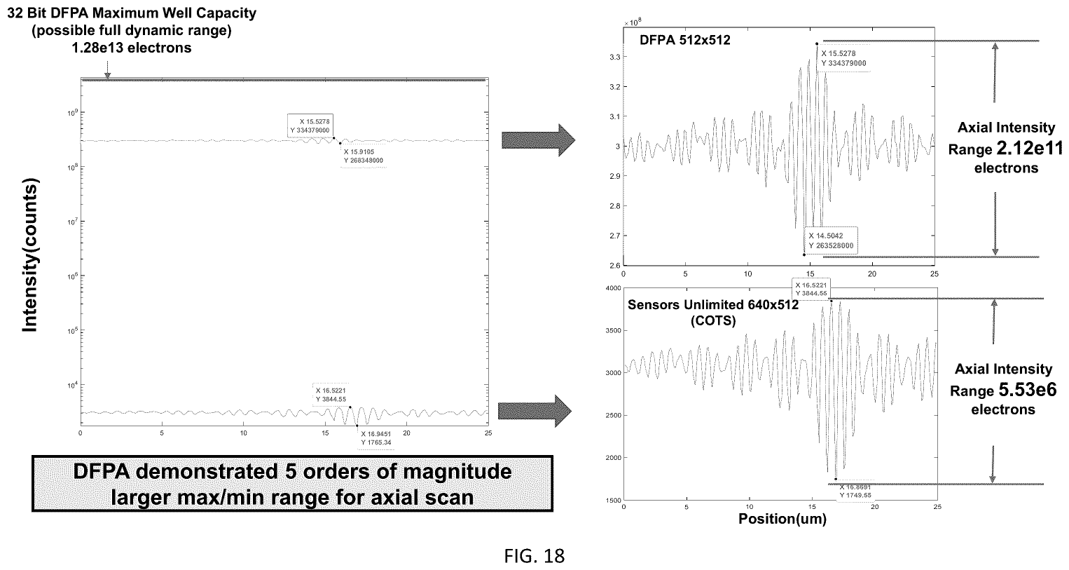

FIG. 16 shows a plot of the theoretical single-frame sensitivity (N=1) calculated with equation (2) if all factors are held constant except the full-well capacity (ξₛₐₜ). Though this calculation neglects DFPA/imager noise, it shows a clear benefit in terms of sensitivity of the DFPA technology, only taking into account the improved dynamic range (i.e. full-well capacity). The years 2004 and 2019 represent cameras that were state-of-the-art at those times, and their resulting single-frame sensitivity (see, respectively: Arnaud Dubois, Kate Grieve, Gael Moneron, Romain Lecaque, Laurent Vabre, and Claude Boccara, “Ultrahigh-resolution full-field optical coherence tomography,” Appl. Opt. 43, 2874-2883 (2004); Jules Scholler, Viacheslav Mazlin, Olivier Thouvenin, Kassandra Groux, Peng Xiao, José-Alain Sahel, Mathias Fink, Claude Boccara, and Kate Grieve, “Probing dynamic processes in the eye at multiple spatial and temporal scales with multimodal full field OCT,” Biomed. Opt. Express 10, 731-746 (2019), each of which is incorporated by reference in its entirety).

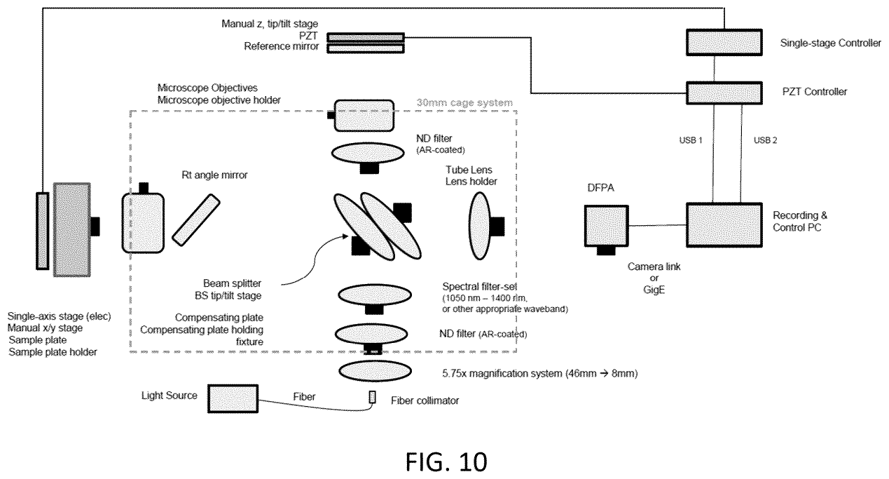

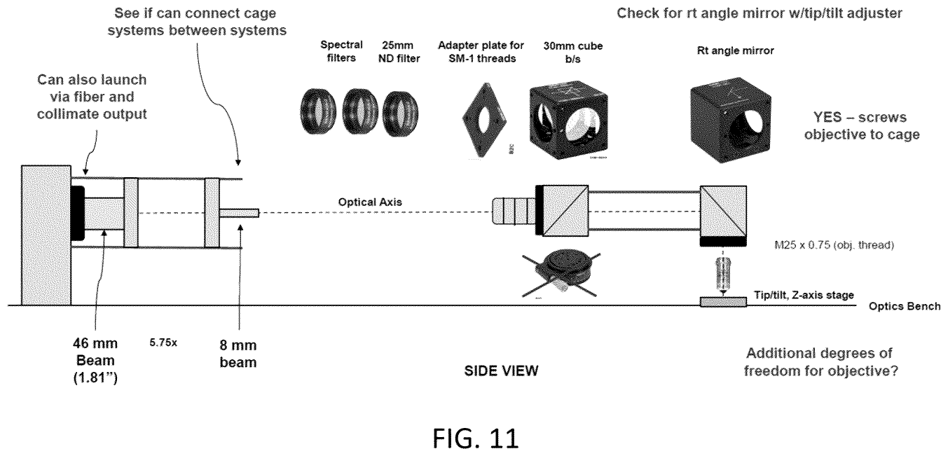

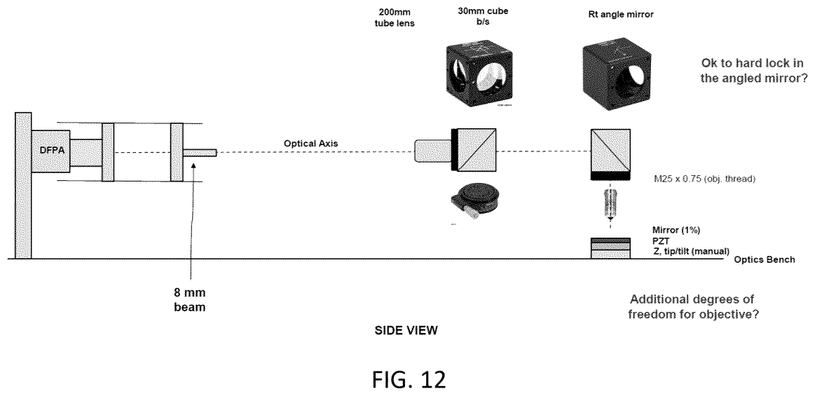

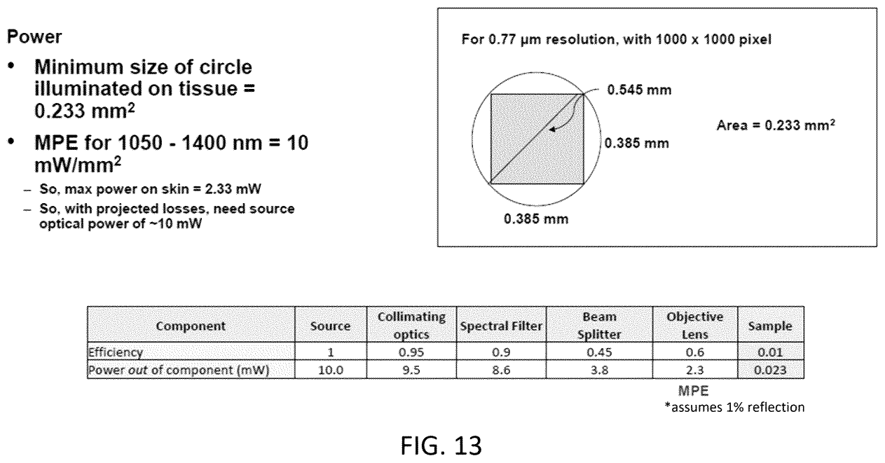

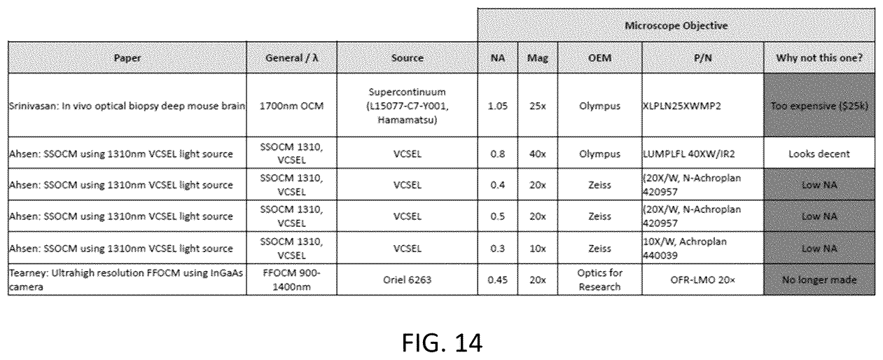

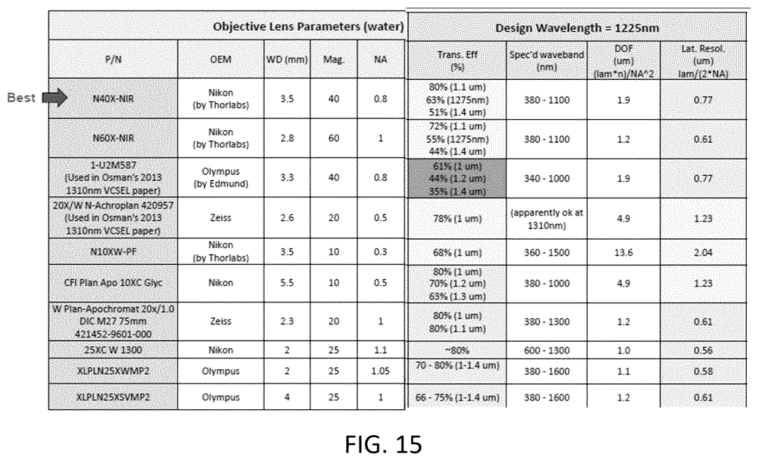

FIG. 10 provides a system block diagram of an embodiment of a DFPA-based FFOCM for performing SIRP. FIG. 11 provides a side view diagram of an embodiment of a SIRP layout showing the coupling between the light source and sample arm, highlighting issues to be addressed. FIG. 12 provides a side view diagram of an embodiment of a SIRP layout showing the coupling between the reference arm and the camera, highlighting issues to be addressed. FIG. 13 provides an analysis of light source power requirements for various embodiments of a SIRP system. FIGS. 14 and 15 and provide analyses of objective lens requirements for various embodiments of a SIRP system.

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto.

1. An apparatus for obtaining interferometric data, comprising:
an optical detector to detect the interferometric data,
the optical detector including at least one pixel, and
the at least one pixel comprising at least one counter configured to count photoelectrons.

2. The apparatus of claim 1, wherein the interferometric data comprises data or images that result from an interferometric combination of a plurality of electromagnetic beams that is measured by the optical detector.

3. The apparatus of claim 1, wherein the at least one pixel of the optical detector comprises a linear array of elements.

4. The apparatus of claim 1, wherein the at least one pixel of the optical detector comprises a two-dimensional array of elements.

5. The apparatus of claim 1, wherein the optical detector comprises a Digital Focal Plane Array (DFPA).

6. The apparatus of claim 1, wherein a responsivity of the optical detector is in a wavelength range determined by a spectral responsivity of a material comprising an optical/electrical interface of the optical detector.

7. The apparatus of claim 1, wherein the optical detector comprises a readout integrated circuit (ROIC), and
wherein a dynamic range of the optical detector is a function of the ROIC.

8. The apparatus of claim 7, wherein the ROIC comprises a 16-bit counter and a capacitor yielding a least significant bit of 2000 electrons such that a pixel saturation level comprises 130×10⁶ photoelectrons.

9. The apparatus of claim 7, wherein the ROIC comprises a 32-bit counter and a capacitor yielding a least significant bit of 2000 electrons such that a pixel saturation level comprises 8.5×10¹² photoelectrons.

10. The apparatus of claim 7, wherein a first counter of the ROIC reads out data while a second counter counts photoelectrons such that the optical detector is configured to perform a read-while-integrate operation.

11. The apparatus of claim 7, wherein a counter of the ROIC is pre-set to remove a DC level corresponding to a background light level.

12. The apparatus of claim 5, wherein the DFPA performs an in-pixel computation.

13. The apparatus of claim 12, wherein the in-pixel computation comprises at least one of addition or subtraction.

14. The apparatus of claim 5, wherein the DFPA comprises a spectral responsivity in a range of 900 nm-1400 nm.

15. The apparatus of claim 5, wherein the DFPA comprises a spectral responsivity in a range of 400 nm-1100 nm.

16. The apparatus of claim 1 any one of the preceding claims, wherein the interferometric data is obtained from an interferometric system comprising an optical coherence microscopy (OCT) imaging system.

17. The apparatus of claim 1, wherein the interferometric data is obtained from an interferometric system comprising a full-field optical coherence microscopy (FFOCM) imaging system.

18. The apparatus of claim 1, wherein the interferometric data is obtained from an interferometric system comprising a Fourier Transform Infrared Spectroscopy (FTIR) system.

19. The apparatus of claim 1, wherein the optical detector comprises readout times supporting a frame rate of at least 1 kHz.

20. The apparatus of claim 1, wherein the optical detector comprises pixel shifting to implement at least one of spatial filtering or image stabilization.

21-40. (canceled)
